(19) United States
(12) Patent Application Publication
(10) Pub. No.: US 2021/0032094 A1
(43) Pub. Date: Feb. 4, 2021

(54) EXTERNAL FUEL LEVEL NOTIFICATION

(71) Applicant: FORD GLOBAL TECHNOLOGIES, LLC, DEARBORN, MI (US)

(72) Inventors: Mahmoud Yousef Ghannam, Canton, MI (US); David Jeffeory Berels, Plymouth, MI (US)

(21) Appl. No.: 16/525,975

(22) Filed: Jul. 30, 2019

(51) Int. Cl. B67D 7/22; B67D 7/86; B60Q 1/50; B60R 1/12

(52) U.S. Cl. CPC B67D 7/22; B67D 7/86; B60S 5/02; B60R 1/1207; B60Q 1/50

(57) ABSTRACT

Indicating a fuel level in a fuel tank of a vehicle during a refueling event may include illuminating exterior vehicle lighting to indicate the fuel level in the fuel tank, adding fuel to the fuel tank, and as the fuel is added to the fuel tank, changing the illumination of the exterior vehicle lighting to indicate the current fuel level in the fuel tank.

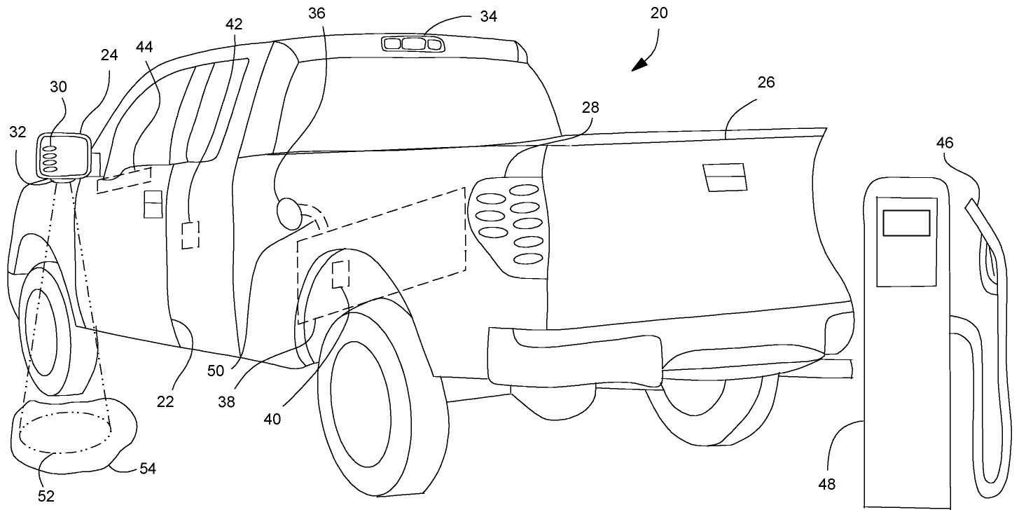

### BACKGROUND OF THE INVENTION

The present invention relates to a method that allows one to know a fuel level while refueling a vehicle.

Currently, automotive vehicles have fuel gauges on internal instrument panels that display how full the fuel tank is. However, they do not generally display the number of liters (gallons) needed to fill the tank, nor do some operate unless the vehicle ignition is on. In many jurisdictions, it is against the law to have the vehicle engine running while refueling. Moreover, when one is outside of the vehicle during fueling, one typically cannot see fuel gauge to note the fuel level progress as the tank is being filled.

Additionally, during some fueling events, the fuel pump might stop fueling the tank due to high pressure in the tank even though the fuel tank is not full. In such situations the vehicle operator may drive away assuming that the fuel tank is full when in fact it is not since one cannot see the fuel gauge while outside of the vehicle.

### SUMMARY OF THE INVENTION

An embodiment contemplates a method of indicating a fuel level in a fuel tank of a vehicle comprising: detecting a refueling event; upon detecting the refueling event, illuminating exterior vehicle lighting to indicate the fuel level in the fuel tank; adding fuel to the fuel tank; and as the fuel is added to the fuel tank, changing the illumination of the exterior vehicle lighting to indicate the current fuel level in the fuel tank.

An embodiment contemplates a vehicle comprising: a fuel tank having a fuel level sensor; exterior lighting; and a controller configured to detect a refueling event and illuminate the exterior vehicle lighting to indicate a fuel level in the fuel tank during the refueling event.

An advantage of an embodiment is that one may observe how full the vehicle fuel tank is while outside of the vehicle during refueling. This additional information may be proved to the vehicle operator while not affecting the vehicle styling or architecture of the exterior lights on the vehicle.

### BRIEF DESCRIPTION OF THE DRAWINGS

The FIGURE is a schematic rear perspective view of an automotive vehicle.

### DETAILED DESCRIPTION

The FIGURE illustrates an automotive vehicle 20 having one or more side doors 22, with side mirrors 24 adjacent to front doors, a rear closure 26, such as a tailgate (or lift-gate, trunk, etc.), with rear lights 28, such as brake lights, adjacent to the rear closure 26. These rear lights 28 may include multiple sources of light within a housing, such as light emitting diodes (LEDs). These LEDs may be arranged in rows and/or columns of LEDs to produce light visible from outside of the vehicle. The vehicle 20 may also include an upper set of lights 34, such as a high mount brake light and possibly rear directed bed or backup lights.

In addition to the rear lights 28, the side mirrors 24 may include lights such as side mirror lights 30, which illuminate through or adjacent to the side mirror surface, and puddle lamps 32, which project light generally downward towards the ground adjacent to the vehicle 20. These lights may also be, for example, LED types of lights.

As is typical with a vehicle having a petroleum powered engine, such as gasoline or diesel, the vehicle 20 has a fuel door 36 that opens to allow one to fill the vehicle fuel tank 38. This fuel door 36 may act as a fuel cap or the vehicle may have a separate fuel cap that is removed during refueling of the vehicle 20. A fuel level sensor 40 is typically located within the fuel tank 38 and provides a signal indicating the level of fuel within the tank 38. While the fuel door and lights are shown for the driver's side of the vehicle 20, this also applies to vehicles with a passenger side fuel door, passenger side mirror and passenger side lights.

The fuel level sensor 40 may communicate with a central processing unit 42, which communicates with an instrument panel 44. Thus, the level of fuel in the tank 38 may be visually indicated to a driver of the vehicle 20. The CPU may also communicate with and control the various lights 28, 30, 32, 34, or communicate with a different on-board CPU that controls these lights. The various CPU(s) that control the lights, instrument panel and other vehicle operation are known to these skilled in the art and so will not be discussed further herein.

The process of indicating the fuel tank level while refueling the vehicle 20 will now be discussed. When the vehicle 20 is stopped, for example as a gas station, with the engine turned off, and with the fuel door 36 (and cap if so equipped) opened, then the CPU 42 detects this as a refueling event. This detection of a refueling event may also include detecting that a nozzle 46 of a fuel pump 48 is inserted past the fuel door 36 into a spout 50, if so desired.

In the refueling event, the CPU activates one or more sets of the lights 28, 30, 32, 34 (or portions thereof) to indicate to the person standing outside of the vehicle 20 the current level of the fuel tank 38. Then, as the fuel tank 38 is being filled by the fuel pump 48, the lighting is altered to reflect the new fuel level in the fuel tank 38. This allows one to determine the fuel level as the tank 38 is being filled, even though the fuel gauge on the instrument panel may not be visible while standing outside of the vehicle 20 near the fuel door 36.

The following discusses examples for how the lighting may be used to reflect the current fuel level in the tank 38 during a refueling event. The rear lights 28 may illuminate progressive rows of lights (such as LEDs) based on the level of fuel in the tank 38, as measured by the fuel level sensor 40. For example, if the tank 38 is one-quarter full, then one row of the rear lights 28 may illuminate. This may, for example, be a blinking row of lights if the tank 38 is less than one-quarter full and then change to a solid light upon reaching one-quarter full. As the fuel level approaches one-half tank, then a second row of the rear lights 28 may be illuminated by blinking. As the fuel level reaches one-half tank, then both the first and second rows of the rear lights 28 illuminate with a solid light. This same process repeats for three-quarters and a full tank, with four rows of the rear lights 28 illuminated. There may be more or less rows of the rear lights 38, with indications at greater or lesser intervals of fuel tank level (e.g., twenty percent or ten percent intervals), if so desired.

Another example for how the lighting may be used to reflect the current fuel level in the tank 38 during a refueling event is similar to the above description, but progressively employing adjacent columns of the rear lights 28 rather than rows.

Another example for how the lighting may be used to reflect the current fuel level in the tank 38 during a refueling event is similar to the description above, but employing rows of the LEDs of the side mirror lights 30 (and upper set of lights 34) in addition to or rather than the rear lights 28.

A further example for how the lighting may be used to reflect the current fuel level in the tank 38 during a refueling event may include illuminating the rear lights 28 during refueling in different colors that represent the fuel tank level. For example, the rear lights 28 may be illuminated in red when the fuel tank 38 is near empty, switch to a yellow illumination when the fuel tank 38 is around half full and then illuminate in green when the fuel tank 38 is close to full or full. This changing of colors may also be applied employing the side mirror lights 30 (and upper set of lights 34) in addition to or rather than the rear lights 28.

Another example for how the lighting may be used to reflect the current fuel level in the tank 38 during a refueling event may include blinking the rear lights 28 the number of times equivalent to the number of liters (gallons) until the fuel tank 38 is full. This blinking may start as the fuel tank 38 is closer to full so as to limit the number of blinks one must count. This blinking of lights may also employ the side mirror lights 30 (and upper set of lights 34) in addition to or rather than the rear lights 28. Alternatively, the blinking of the rear lights 28, side mirror lights 30 and/or upper lights 34 may increase (or decrease) in frequency as the fuel level in the fuel tank 38 increases.

A further example for how the lighting may be used to reflect the current fuel level in the tank 38 during a refueling event may include projecting an image 52 onto the ground 54 with the puddle lamps 32 that indicates how full the tank is (e.g., one-quarter full) or indicates how many liters (gallons) left until the fuel tank 38 is full.

While certain embodiments of the present invention have been described in detail, those familiar with the art to which this invention relates will recognize various alternative designs and embodiments for practicing the invention as defined by the following claims.

1. A method of indicating a fuel level in a fuel tank of a vehicle comprising:
(a) automatically detecting a refueling event;
(b) upon detecting the refueling event, illuminating exterior vehicle lighting to indicate the fuel level in the fuel tank;
(c) adding fuel to the fuel tank; and
(d) as the fuel is added to the fuel tank, changing the illumination of the exterior vehicle lighting to indicate the current fuel level in the fuel tank.

2. The method of claim 1 wherein step (b) includes illuminating a portion of rear lights on the vehicle, and step (d) includes illuminating more rows of the rear lights as the fuel level in the fuel tank increases.

3. The method of claim 2 wherein step (d) further includes solidly illuminating predetermined rows of lights below a current fuel level while blinking a row of lights indicating that the current fuel level is approaching a predetermined higher fuel level, and then changing the blinking row of lights to a solid illumination upon reaching the predetermined higher fuel level.

4. The method of claim 1 wherein step (b) includes illuminating a portion of rear lights on the vehicle, and step (d) includes illuminating more columns of the rear lights as the fuel level in the fuel tank increases.

5. The method of claim 1 wherein step (b) includes illuminating a portion of side mirror lights on the vehicle, and step (d) includes illuminating more of the side mirror lights as the fuel level in the fuel tank increases.

6. The method of claim 1 wherein step (b) includes illuminating a portion of an upper set of lights on the vehicle, and step (d) includes illuminating more of the upper set of lights as the fuel level in the fuel tank increases.

7. The method of claim 1 wherein step (b) includes illuminating at least a portion of the exterior vehicle lighting all in one predetermined color, and step (d) includes changing the color of all of the illuminated exterior vehicle lighting as the fuel level in the fuel tank increases.

8. The method of claim 1 wherein step (b) includes illuminating at least a portion of the exterior vehicle lighting by blinking at a predetermined frequency, and step (d) includes changing the frequency of the blinking of the illuminated exterior vehicle lighting as the fuel level in the fuel tank increases.

9. The method of claim 1 wherein step (d) includes blinking the illuminated exterior vehicle lighting the number of times equivalent to a number of units of the fuel needed to completely fill a remaining empty portion of the fuel tank.

10. The method of claim 9 wherein the units of the fuel are one of gallons and liters.

11. The method of claim 1 wherein step (b) includes illuminating a puddle lamp to project the fuel level of the fuel tank onto another surface.

12. A vehicle comprising:
a fuel tank having a fuel level sensor;
exterior lighting; and
a controller configured to automatically detect a refueling event and illuminate the exterior vehicle lighting to indicate a fuel level in the fuel tank during the refueling event.

13. The vehicle of claim 12 wherein the exterior lighting includes rear lights, and the controller is configured to change the illumination of the rear lights as the fuel level in the fuel tank changes.

14. The vehicle of claim 12 wherein the exterior lighting includes side mirror lights, and the controller is configured to change the illumination of the side mirror lights as the fuel level in the fuel tank changes.

15. The vehicle of claim 12 wherein the exterior lighting includes a puddle lamp, and the controller is configured to change the illumination of the puddle lamp onto another surface as the fuel level in the fuel tank changes.

16. The method of claim 1 wherein step (a) includes automatically detecting the refueling event when the vehicle is stopped, an engine is turned off and a fuel door is open.

17. The method of claim 1 wherein step (a) includes automatically detecting the refueling event when a nozzle is inserted into a refueling spout.

18. The vehicle of claim 12 wherein the controller is configured to automatically detect the refueling event when the vehicle is stopped, an engine is turned off and a fuel door is open.

19. The vehicle of claim 12 wherein the controller is configured to automatically detect the refueling event when a nozzle is inserted into a refueling spout.
